(19) United States
(12) Patent Application Publication
(10) Pub. No.: US 2025/0335813 A1
(43) Pub. Date: Oct. 30, 2025

(54) Secure Evaluation Of An Artificial Intelligence Engine

(71) Applicant: Zoom Communications, Inc., San Jose, CA (US)

(72) Inventors: Pengcheng He, Redmond, WA (US); Xuedong David Huang, Yarrow Point, WA (US); Sunoj Ram Ramachandran, Leander, TX (US); Chenguang Zhu, Issaquah, WA (US)

(21) Appl. No.: 18/647,576

(22) Filed: Apr. 26, 2024

(51) Int. Cl. G06N 20/00

(52) U.S. Cl. CPC G06N 20/00

(57) ABSTRACT

Techniques for the secure evaluation of an artificial intelligence engine are disclosed. A computer system transmits, to a testing environment by a scoring engine, a dataset associated with an input for an artificial intelligence model to execute within the testing environment. The scoring engine comprises at least one transformer. The computer system receives, by the scoring engine and from the testing environment, a response to the dataset generated by the artificial intelligence model. The computer system determines, by the scoring engine and based on the response, a score representing a quality of the response. The computer system generates, by the scoring engine, an output based on the score.

### FIELD

This disclosure relates to the secure evaluation of an artificial intelligence engine. The secure evaluation of an artificial intelligence engine may be performed using software or hardware.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a system in which the secure evaluation of an artificial intelligence engine may be performed.

FIG. 5 is a data flow diagram of an example of the secure evaluation of an artificial intelligence engine.

FIG. 6 illustrates a first example of information produced in the secure evaluation of an artificial intelligence model.

FIG. 7 illustrates a second example of information produced in the secure evaluation of an artificial intelligence model.

FIG. 8 illustrates an example of a graphical user interface (GUI) displaying output associated with the secure evaluation of artificial intelligence engines.

FIG. 9 is a flowchart of an example of a technique for the secure evaluation of an artificial intelligence engine.

### DETAILED DESCRIPTION

Advanced general-purpose transformer-based artificial intelligence (AI) models are capable of performing many natural language processing (NLP) tasks, such as summarizing an article or identifying action items in an email message, at a level similar to that of a human. However, such models typically require large amounts of computing resources for their performance or operate slowly (e.g., requiring around 10 seconds to generate a response). Lighter and/or faster AI models that perform specific NLP tasks (e.g., summarizing a recording of a contact center engagement in the banking industry) may be desirable. Such an AI model may be trained manually, for example, by having a human review and rate the output of the AI model. However, in some cases, leveraging a human reviewer may be expensive or impractical. Techniques for automatically training AI models may be desirable. Furthermore, an entity training AI models may desire to train the AI models without providing the AI models with access to proprietary data (e.g., data of customers or users of the entity). Techniques for securely training AI models without providing them with access to the proprietary data may be desirable.

Implementations of this disclosure address problems such as these by leveraging a general-purpose transformer-based AI engine to train other AI models, which may be lighter and/or faster than the general-purpose transformer-based AI engine and/or designed for more specialized tasks. A programmer develops an AI model and stores the AI model in a testing environment. The testing environment may be a sandbox that restricts access of the AI model to network-based data, proprietary data, and/or stored data of a communication service or other entity (e.g., to prevent the use of those data in training or testing of the AI model).

A scoring engine, which includes the general-purpose transformer-based AI engine, is used to test the AI model. The scoring engine transmits a dataset associated with an input for the AI model to the testing environment. The dataset may include, for example, a prompt (e.g., identify tasks for Ben Bitdiddle based on last Monday's all-hands meeting) and additional information to process the prompt (e.g., a transcript of the all-hands meeting). The scoring engine receives, from the AI model in the testing environment, an output generated in response to the dataset.

The scoring engine determines, using the general-purpose transformer-based AI engine, a score representing the quality of the output. For example, the scoring engine may prompt the general-purpose transformer-based AI engine to determine whether the output is acceptable or unacceptable, to rate the output as passing or failing, to rate the output on a scale of 0-10, or to assign a letter grade (e.g., A, B, C, D or F) to the output. The scoring engine may generate a visual output indicating the score, which may be provided to a client device of the programmer or an administrator and/or displayed on a dashboard rating various AI models, including the AI model. In some cases, the score and/or additional feedback on the output generated by the general-purpose transformer-based AI engine may be used to further train the AI model (e.g., using online learning).

As used herein, the phrase “natural language” may include a language that is spoken or written by humans and that evolved naturally through its use by humans. A natural language may be distinct from a formal logical language or from a programming language. Examples of natural languages include, without limitation, at least one of English, French, Spanish, Chinese, Japanese, or Korean. A natural language may include a combination of two or more spoken or written languages (e.g., colloquially, Spanglish, which combines English words and Spanish words into a single phrase or sentence).

In some examples of the present disclosure, implementations may include or otherwise use one or more artificial intelligence or machine learning (collectively, AI/ML) systems having one or more models trained for one or more purposes. Use or inclusion of such AI/ML systems, such as for implementation of certain features or functions, may be turned off by default, where a user, an organization, or both must opt-in to utilize the features or functions that include or otherwise use an AI/ML system. User or organizational consent to use the AI/ML systems or features may be provided in one or more ways, for example, as explicit permission granted by a user prior to using an AI/ML feature, as administrative consent configured by administrator settings, or both. Users for whom such consent is obtained can be notified that they will be interacting with one or more AI/ML systems or features, for example, by an electronic message (e.g., delivered via a chat or email service or presented within a client application or webpage) or by an on-screen prompt, which can be applied on a per-interaction basis. Those users can also be provided with an easy way to withdraw their user consent, for example, using a form or like element provided within a client application, webpage, or on-screen prompt to allow individual users to opt-out of use of the AI/ML systems or features.

To enhance privacy and safety, as well as provide other benefits, the AI/ML processing system may be prevented from using a user's or organization's personal information (e.g., audio, video, chat, screen-sharing, attachments, or other communications-like content (such as poll results, whiteboards, or reactions)) to train any AI/ML models and instead only use the personal information for inference operations of the AI/ML processing system. Instead of using the personal information to train AI/ML models, AI/ML models may be trained using one or more commercially licensed data sets that do not contain the personal information of the user or organization.

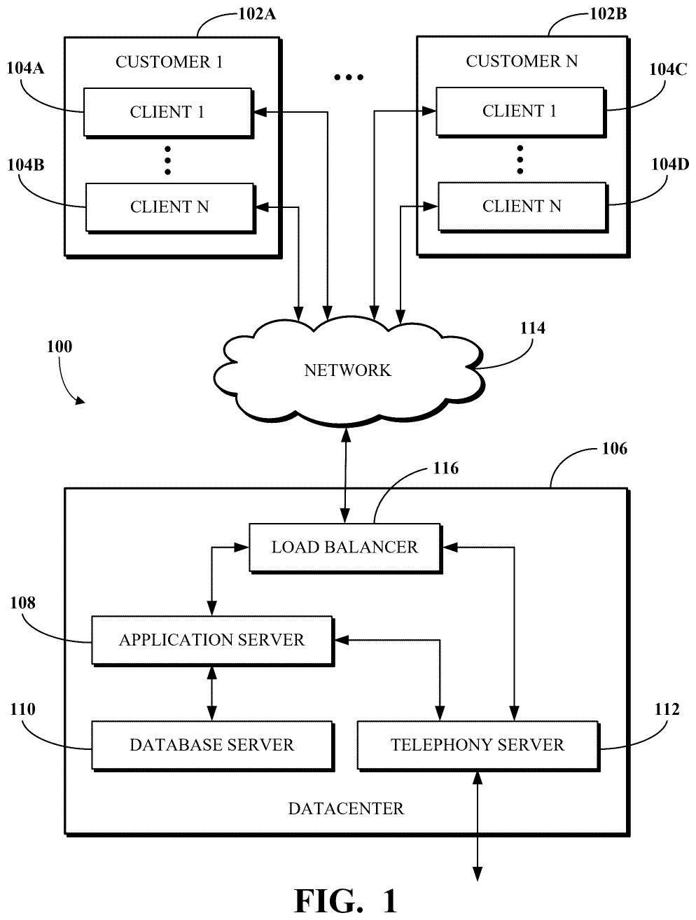

To describe some implementations in greater detail, reference is first made to examples of hardware and software structures used to implement a system for the secure evaluation of an artificial intelligence engine. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a unified communications as a service (UCaaS) platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UcaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UcaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UcaaS platform. For example, the application server 108 can implement all or a portion of a UcaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and to clients of a customer, such as the clients 104A through 104B for the customer 102A or the clients 104C through 104D for the customer 102B. Some or all of the clients 104A through 104D may be voice over internet protocol (VOIP)-enabled devices configured to send and receive calls over a network 114. In particular, the telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

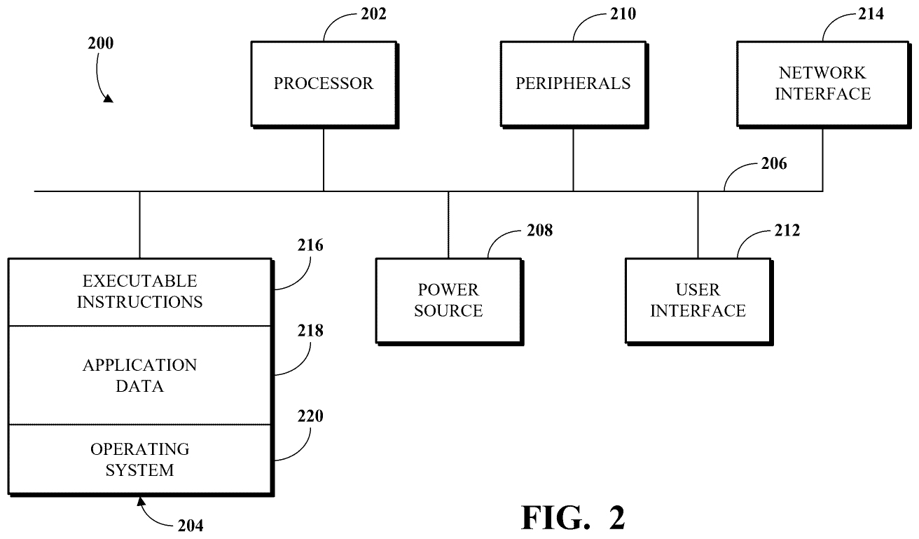

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

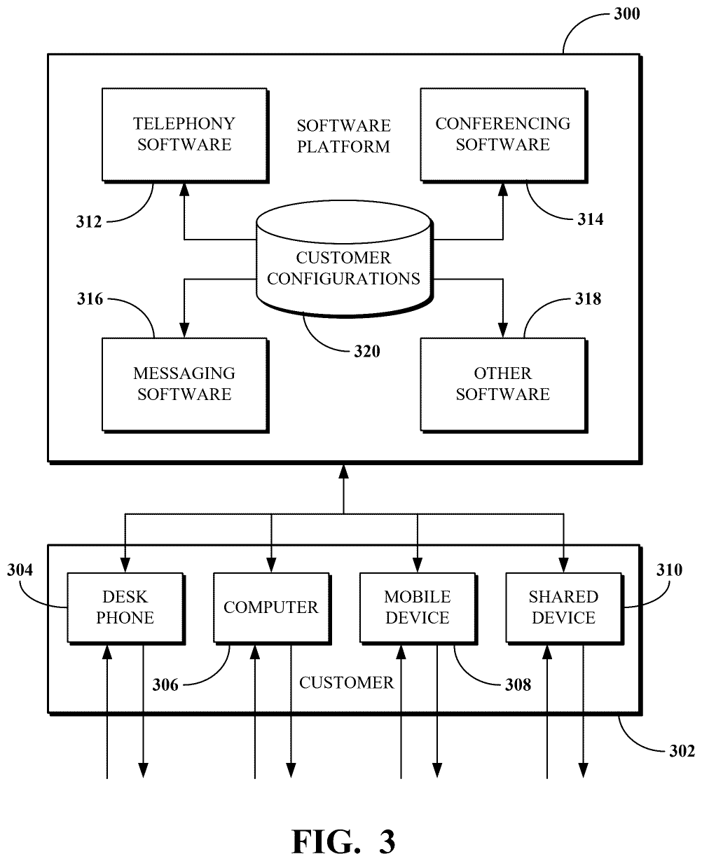

FIG. 3 is a block diagram of an example of a software platform 300 implemented by an electronic computing and communications system, for example, the system 100 shown in FIG. 1. The software platform 300 is a UcaaS platform accessible by clients of a customer of a UcaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients—a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include software for the secure evaluation of an artificial intelligence engine and/or software for other engines as described herein.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

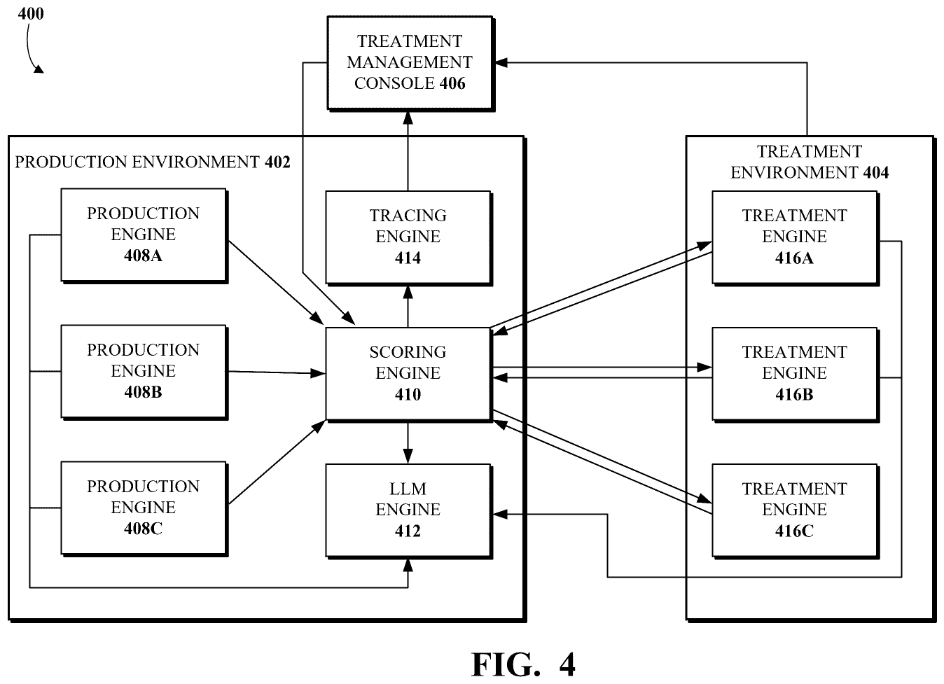

FIG. 4 is a block diagram of an example of a system 400 in which the secure evaluation of an artificial intelligence engine may be performed. As shown, the system 400 includes a production environment 402, a treatment environment 404, and a treatment management console 406.

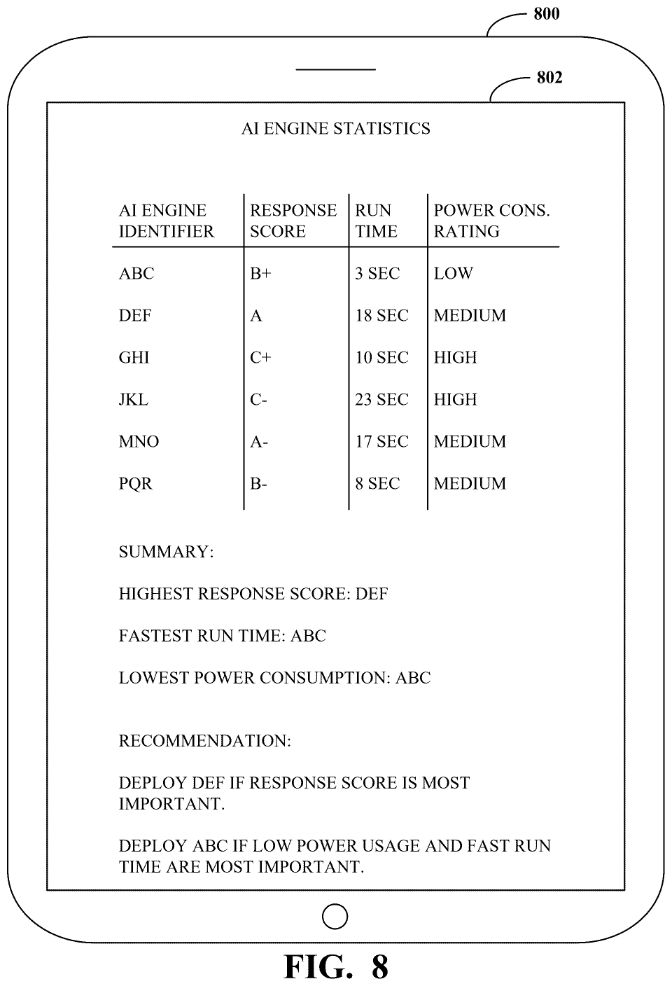

The production environment 402 is used for development and inference of AI engines. The treatment environment 404 provides a sandboxed environment where the AI engines may be tested without access to entity data. Entity data may include private data or proprietary data of entities such as businesses, non-profit organizations or government organizations. For example, an insurance company may store data about policies and claims of its customers. The treatment environment 404 may lack access to the data about the policies and the claims of the customers, allowing AI engines stored in the treatment environment 404 to be trained without accessing those data. The treatment management console 406 manages the registration and/or deregistration of AI engines in the treatment environment. In some cases, the treatment management console 406 generates a dashboard displaying information about the AI engines, as described in greater detail below in conjunction with FIG. 8.

As shown, the production environment 402 stores production engines 408A-C, a scoring engine 410, a LLM engine 412, and a tracing engine 414. The treatment environment 404 includes treatment engines 416A-C. Each production engine 408A is an AI model, for example, a specialized AI model for summarizing a video conference or a specialized AI model for identifying action items for a user based on at least one of a video conference recording, a set of emails, or a set of messages in a chat session. Each treatment engine 416A-C is associated with a corresponding production engine 408A-C and includes software code similar to the corresponding production engine 408A-C. However, the treatment engines 416A-C execute within the treatment environment 404 and may be restricted from accessing certain data outside the treatment environment 404.

A programmer programs a production engine 402A (or one of 402B-C) and stores it in the production environment 402. The treatment engine 416A corresponds to the production engine 408A. (Similarly, the treatment engine 416B corresponds to the production engine 408B, and the treatment engine 416C corresponds to the production engine 408C.) The treatment management console 406 registers the production engine 408A and adds the treatment engine 416A corresponding to the production engine 408A. The treatment management console 406 stores a record (e.g., a table or another data structure) mapping the production engine 408A to the corresponding treatment engine 416A. The record includes a mapping of each treatment engine 416A-C to the corresponding production engine 408A-C. The record may be provided, by the treatment management console 406, to the scoring engine 410.

In some cases, the treatment environment 404 obtains an AI model for the treatment engine 416A from the production engine 408A. The treatment environment 404 stores that AI model in the treatment engine 416A of the treatment environment 404. The treatment engine 416B is similarly generated from an AI model of the production engine 408B. The treatment engine 416C is similarly generated from an AI model of the production engine 408C.

The scoring engine 410 determines a score of the responses generated by the treatment engine 416A, the treatment engine 416B, and/or the treatment engine 416C. The scoring engine 410 broadcasts traffic (e.g., a prompt and information for responding to the prompt that excludes entity data) to the treatment engines 416A-C according to instructions provided to the scoring engine 410 by the entity (e.g., from an administrator device of an information technology administrator of the entity). The scoring engine 410 provides an application programming interface (API) that scores outputs generated by the treatment engines 416A-C and transmits data to the treatment engines 416A-C. The scoring engine 410 provides a scoring function version control API that allows for access to prompts, LLM versions of the LLM engine 412, and/or algorithms to make the results reproducible.

The LLM engine 412 may be a general purpose LLM that is capable of generating natural language responses to natural language prompts. However, the LLM engine 412 might not be optimized for some use cases due to at least one of low processing speed, high power usage, and/or lack of specific knowledge (e.g., associated with a specific industry or a specific dataset).

The treatment engine 416A receives, from the scoring engine 410, a request including a prompt and information (e.g., fictitious entity information generated for testing purposes) for responding to the prompt. The prompt may be, include, or otherwise correspond to a prompt provided to the production engine 408A. The treatment engine 416A generates a response based on the request and transmits the response to the scoring engine 410.

As set forth above, the treatment engine 416A may include some of the software code of the production engine 408A. The treatment engine 416A may include router middleware or a wrapper over API calls to ensure that the treatment engine 416A only accesses the request and other data (e.g., public data on a public network) accessible via the treatment environment 404. The middleware or the wrapper may ensure that the treatment engine 416A does not access entity data that is not included in the request.

As illustrated in FIG. 4, the scoring engine 410 and the treatment engines 416A-C communicate with the LLM engine 412. The scoring engine 410 communicates with the LLM engine 412 to generate scores for responses, and the treatment engines 416A-C may communicate with the LLM to interpret the prompt. The communication of the scoring engine 410 with the LLM engine 412 and/or the communication of the treatment engines 416A-C with the LLM engine 412 may be throttled to reduce power, processing circuitry, or memory usage of the LLM engine 412 and/or to increase the speed of responses of the LLM engine 412 to other inputs (e.g., from the production engines 408A-C).

According to some implementations, the scoring engine 410 transmits, to the treatment environment 404, a dataset associated with an input for the treatment engine 416A to execute within the treatment environment 404. For example, the dataset may include the prompt, “Identify action items for Ben Bitdiddle from the all-hands meeting,” and a transcript of the all-hands meeting. The scoring engine 410 receives, from the treatment engine 416A, a response to the dataset generated by the treatment engine 416A. For example, the response may include the action items: “book block of hotel rooms for retreat,” and “book conference room for summit meeting,” and “set up video conference for remote attendees of summit meeting.” The scoring engine 410 uses the LLM engine 412 to determine a score representing a quality of the response. The score may be a pass/fail score indicating whether the response is adequate. Alternatively, the score may be more nuanced. For example, the score may be a letter grade (e.g., A, B, C, D or F) or a numeric score (e.g., between 0 and 100) representing how well the response answers the prompt in the dataset according to the LLM engine 412.

The scoring engine 410 transmits the score (or an output based on the score) to the tracing engine 414. The tracing engine 414 obtains multiple scores of multiple outputs by multiple treatment engines 416A-C and generates a combined score for some or all of the treatment engines 416A-C. The combined score represents how well the associated treatment engine 416A-C responds to different prompts for which the treatment engine 416A-C was developed. For example, the combined score may correspond to a percentage of passing scores if the scores are pass/fail or an average letter grade or numeric score (similar to how a student's grade for a course may correspond to the average (or a weighted average) of their grades on multiple assignments in the course).

As used herein, the phrase “sandboxed environment” may refer to, among other things, a secure, isolated testing environment where code may be executed without the risk of impacting an external system (e.g., which stores the entity data). The sandboxed environment may lack access to the external system. A sandboxed environment may limit access to files, memory, and/or network resources to engines executing within the sandboxed environment.

In accordance with some implementations of the disclosed technology, the treatment engines 416A-C may be tested in a secure, sandboxed environment (the treatment environment 404). As a result, the testing is done without exposing proprietary data of an entity to the treatment engines 416A-C being tested. This allows the entity to prevent the use of proprietary data in the development of AI engines.

In some implementations, the scoring engine 410 and/or the LLM engine 412 includes a GPT engine, for example, to evaluate the responses generated by the treatment engines 416A-C. In some cases, the GPT engine that is trained using a two-phase process including the phases of pretraining and finetuning. In the pretraining phase, the GPT engine is trained on a dataset of publicly available (e.g., from the Internet) text or audio/video data that is converted into text using speech-to-text technology. The dataset of publicly available text may include text that is distinct from evaluation of outputs of AI engines being tested. For example, the dataset of publicly available text may include at least one of newspaper articles, blog posts, publicly available social media post, or encyclopedia articles. The text is used to create a language model that learns to predict the next word in a sentence given the context of the previous words. The transformer architecture, specifically the self-attention mechanism, is used to capture dependencies between words and create a representation of the text.

During pretraining, the GPT engine learns to generalize the patterns it observes in the training data. Specifically, the GPT engine learns grammar, facts, reasoning abilities, and some level of world knowledge. The pretraining phase allows the GPT engine to acquire a broad understanding of the natural languages in which the GPT engine is trained.

During the finetuning phase, after pre-training, the GPT engine is further finetuned on specific tasks (e.g., evaluating natural language outputs generated by AI engines) using labeled examples. The labeled examples may be manually generated examples of high-quality and low-quality responses to prompts that could be provided to AI engines. The manually generated data is generated specifically for training the GPT engine and the users manually generating the data are aware of this planned use. The labeled examples may include labels of desired outputs that the GPT is to generate based on the inputs. For example, the labeled examples may include actual outputs of some AI engines being developed, and ratings generated by humans of those actual outputs. The finetuning phase makes the GPT engine useful for specific applications, such as evaluating natural language outputs generated by the AI engines. Finetuning involves training the GPT engine on a narrower dataset that may be generated with the help of human reviewers. Specifically, an entity associated with the finetuning process might hire human reviewers (e.g., members of a quality assurance department) to generate the narrower dataset. As a result, the entity does not rely on user data in training the GPT (or other AI/ML) technology.

The finetuning phase includes providing prompts or instructions to the GPT engine and receiving responses from the GPT engine. For example, the GPT engine may be prompted to review publicly available high-quality and low-quality responses to prompts (e.g., high-quality and low-quality answers on a state bar exam, based on data provided by the attorney licensing board of the state and based on bar preparation books the use of which is licensed from the copyright holder). The human reviewer then reviews the output generated by the GPT engine and score the output according to the various qualities (e.g., did the GPT engine correctly identify the high-quality responses and the low-quality responses). The GPT engine uses reinforcement learning to attempt to improve its scores on each (or at least a subset) of the qualities as the finetuning process progresses.

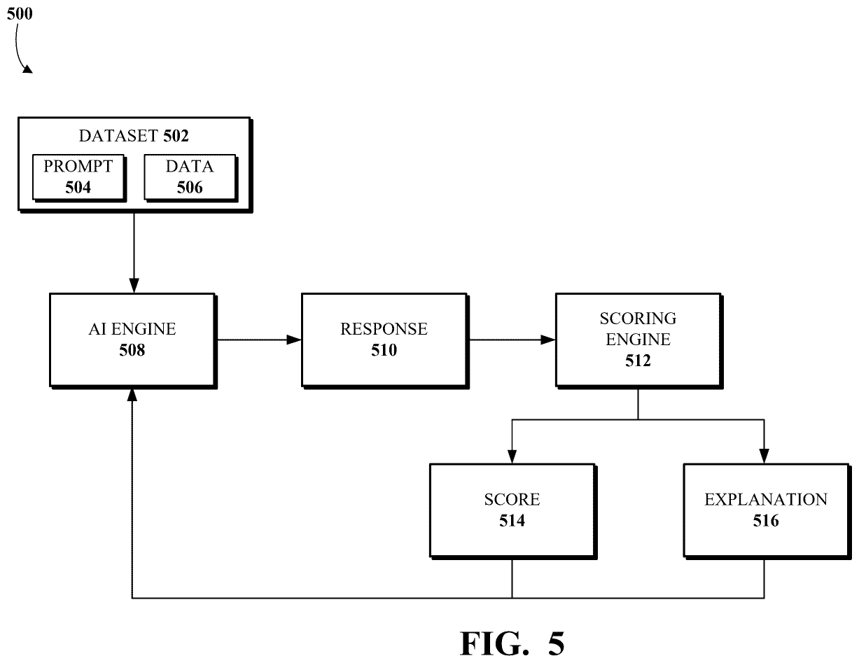

FIG. 5 is a data flow diagram 500 of an example of the secure evaluation of an artificial intelligence engine.

As shown in the data flow diagram 500, a dataset 502 including a prompt 504 and data 506 is provided to an AI engine 508. The AI engine 508 may execute within the treatment environment 404 and may correspond to one of the treatment engines 416A-C. The AI engine 508 may be a special purpose AI engine developed for a specialized NLP task, such as summarizing long articles or identifying the role of a speaker in a video conference. The dataset 502 includes information provided to the AI engine 508, as the AI engine 508 may lack access to internal data of an entity and/or to an external network (e.g., the Internet). The AI engine 508 generates a response 510 based on the dataset 502.

As shown, the dataset 502 includes a prompt 504 and data 506. The prompt 504 may be a question or another query for the AI engine 508. The data 506 may include data for responding to the prompt 504. The AI engine 508 may generate the response 510 to reply to the prompt 504 based on the data 506. In one example, the prompt 504 is a question, such as, “What are the causes of the US Civil War?” The data 506 is a recording or a transcript of a lecture about the US Civil War or an article about the US Civil War that may be used to respond to the prompt 504. (It should be noted that the data 506 may be biased data, for example, an article by a confederate leader, which may cause the response 510 to be different from a response that would have been generated had the AI engine 508 had access to other information.) In another example, the prompt 504 requests a summary of a video conference or action items for a user based on the video conference, and the data 506 includes a recording or a transcript of the video conference.

As illustrated, the response 510 is provided to a scoring engine 512. The scoring engine 512 may correspond to the scoring engine 410. The scoring engine 512 may be an NLP engine configured to evaluate the response 510 generated by AI engine 508. The scoring engine 512 may incorporate artificial intelligence techniques and may be a larger (e.g., in terms of access to time, electric power, processing hardware, and/or memory hardware) than the AI engine 508, allowing the scoring engine 512 to evaluate the work of the AI engine 508 and/or to perform NLP tasks at a higher level than the AI engine 508. For example, the scoring engine 512 may include at least one of an LLM or a GPT.

As shown, the scoring engine 512 outputs a score 514 and an explanation 516. The score may be a Boolean score (e.g., pass or fail), a numeric score (e.g., between 0 and 1 or between 0 and 100), or another type of score (e.g., a letter grade such as A− or B+) assessing a quality of the response 510. The explanation 516 may be a natural language explanation of the reasoning for why the score 514 was assigned to the response 510 and may include feedback for the AI engine 508 based on the response 510 and/or for improving the response 510. The explanation 516 may include suggested improvements for the response 510. The score 514 and/or the explanation 516 are provided to the AI engine 508 for recursive training (e.g., online learning) of the AI engine 508. As a result, the AI engine 508 may improve its performance on generating responses to datasets based on the score 514 and/or the explanation 516. This is similar to how a student may incorporate feedback of a teacher, or how a trainee may incorporate feedback of a trainer.

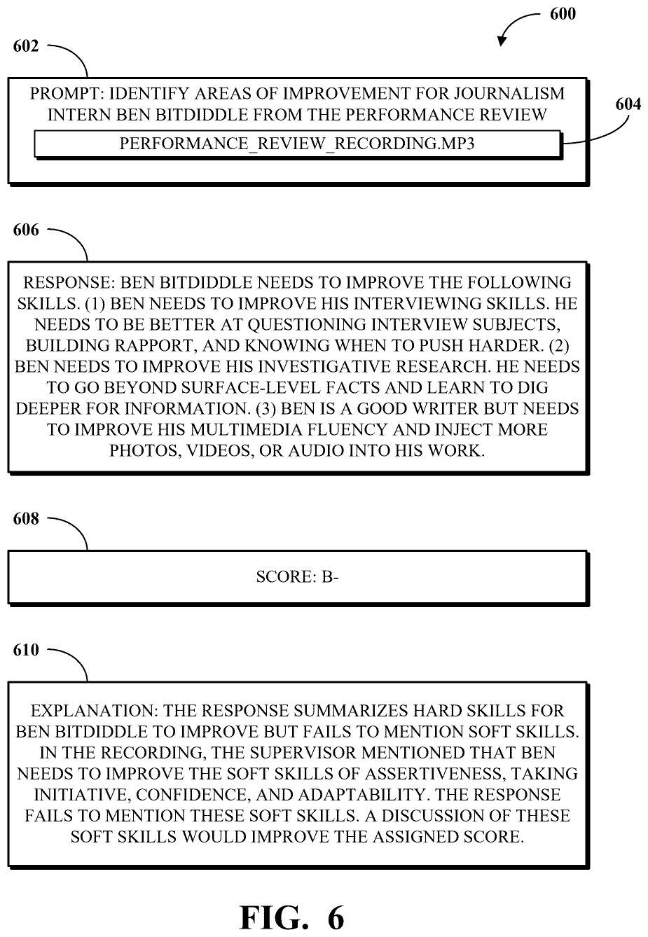

FIG. 6 illustrates an example of information 600 produced in the secure evaluation of an artificial intelligence model, which may be generated in an example use case of some implementations the disclosed technology. As shown, the information 600 includes a dataset 602 (which includes data 604), a response 606, a score 608, and an explanation 610.

As illustrated, the dataset 602 includes a prompt—“Identify areas of improvement for journalism intern Ben Bitdiddle from the performance review”—and data 604 (an MP3 audio file including a recording of Ben Bitdiddle's performance review conference) for responding to the prompt. The dataset 602 may correspond to the dataset 502 in FIG. 5, which is provided to the AI engine 508. In this example, the AI engine 508 may be a specialized AI agent that is configured to identify areas of improvement for a person based on a recording of the person's performance review. The AI engine 508 generates the response 606, corresponding to the response 510 in FIG. 5. The response 606 identifies hard skills for Ben to improve—interviewing skills, investigative research, and multimedia fluency. The response 606 is provided to the scoring engine 512. Thee scoring engine 512 generates the score 608 (corresponding to the score 514) and the explanation 610 (corresponding to the explanation 516) based on the response 606.

To generate the response 606, the AI engine 508 executes within the treatment environment 404. Thus, the AI engine 508 may be prevented from accessing certain data (e.g., proprietary data) other than the dataset 602. For example, the AI engine 508 might be prevented from accessing other employee data, other performance reviews, or confidential data of the journalism company for which Ben Bitdiddle works.

As shown, the score 608 is a B−, which represents adequate but not particularly strong performance. The explanation 610 provides reasoning why the score 608 was assigned. Specifically, the explanation 610 states that the response 606 summarized the hard skills for Ben Bitdiddle but failed to summarize the soft skills of assertiveness, taking initiative, confidence, and adaptability that the supervisor mentioned. The explanation 610 provides suggested improvements for the response 606 by stating that the score 608 could be improved by discussing these soft skills in the response 606. The explanation 610 and the score 608 are provided to the AI engine 508 for further training of the AI engine 508 via online learning.

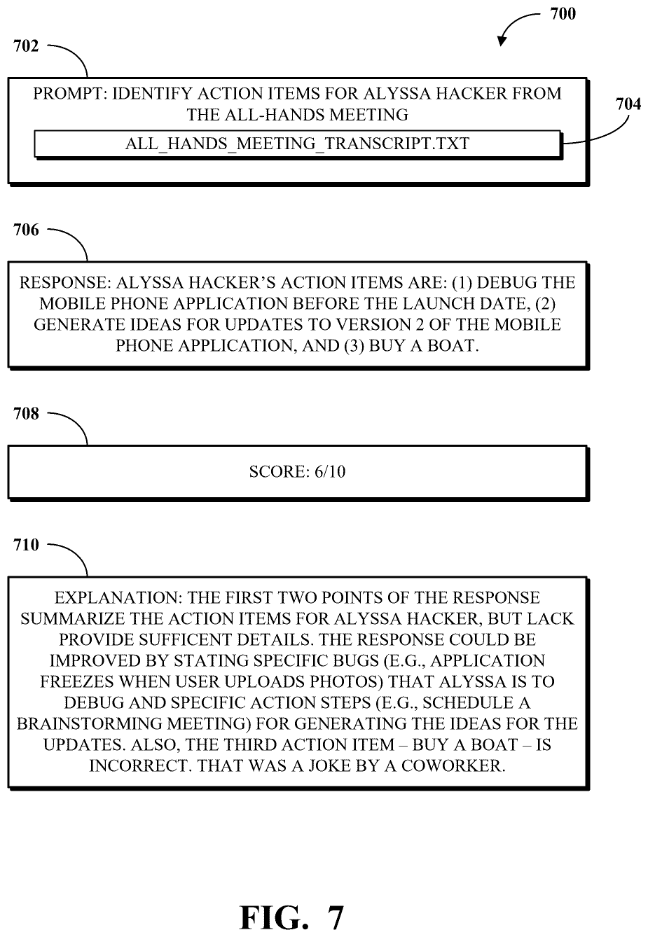

FIG. 7 illustrates an example of information 700 produced in the secure evaluation of an artificial intelligence model, which may be generated in an example use case of some implementations the disclosed technology. As shown, the information 700 includes a dataset 702 (which includes data 704), a response 706, a score 708, and an explanation 710.

As illustrated, the dataset 702 includes a prompt—“Identify action items for Alyssa Hacker from the all-hands meeting”—and data 604 (a text file including a transcript of the all-hands meeting) for responding to the prompt. The dataset 702 may correspond to the dataset 502 in FIG. 5, which is provided to the AI engine 508. In this example, the AI engine 508 may be a specialized AI agent that is configured to identify action items for a user from a transcript of a meeting. The AI engine 508 generates the response 706, corresponding to the response 510 in FIG. 5. The response 706 identifies there action items—debug the mobile phone application, generate ideas for updates, and buy a boat. The response 706 is provided to the scoring engine 512. Thee scoring engine 512 generates the score 708 (corresponding to the score 514) and the explanation 710 (corresponding to the explanation 516) based on the response 606.

To generate the response 706, the AI engine 508 executes within the treatment environment 404. Thus, the AI engine 508 may be prevented from accessing certain data (e.g., proprietary data) other than the dataset 702. For example, the AI engine 508 might be prevented from accessing employee data, transcripts or recordings of other meetings, or confidential data of the company for which Alyssa Hacker works.

As shown, the score 708 is 6/10, which represents poor performance. The explanation 710 provides reasoning why the score 708 was assigned. Specifically, the explanation 710 states that the response 706 did not provide sufficient details for the first two action items—debugging and generating ideas—and incorrectly identified the third action item—buying a boat. The explanation 710 provides examples of details that could be added to the debugging and generating ideas action items. The explanation 710 explains why buying a boat action item is incorrect—it was a joke by a coworker, which the AI engine 508 incorrectly identified as an actual action item. The explanation 710 and the score 708 are provided to the AI engine 508 for further training of the AI engine 508 via online learning.

FIG. 8 illustrates an example of a GUI displaying output associated with the secure evaluation of artificial intelligence engines. As shown, the GUI is displayed on a mobile device 800 that has a screen 802. In alternative implementations, the GUI may be presented on one or more displays of at least one of a mobile device, a tablet computer, a desktop computer, a laptop computer, or another type of computing device.

The GUI includes a table with columns for AI agent identifier, response score, run time, and power consumption (cons.) rating. Each row is associated with an AI engine identified by the AI engine identifier, which is a string. The response score for the AI engine identifier is a letter grade (e.g., A+, A, A−, B+, B, B−, C+, C, C−, D, or F) associated with a quality of one or more responses generated by the AI engine. The runtime represents an average runtime (e.g., in seconds) of one or more executions of the AI engine. The power consumption rating rates how much power is consumed by the AI engine. As shown, the power consumption rating is one of “low,” “medium,” or “high.” The response score may be determined using the techniques disclosed herein, for example, in conjunction with FIGS. 4-7. The runtime may be measured by determining a time (e.g., on a clock of a computing device) at a start time and an end time of execution of the AI engine, and calculating a time difference between the start time and the end time. The power consumption may be determined by measuring power obtained from a power source (e.g., a battery or an electric grid) by processing circuitry during execution of the AI engine.

The GUI includes a summary section. The summary section specifies the AI engine identifier associated with the highest response score, the AI engine identifier associated with the fastest run time, and the AI engine identifier associated with the lowest power consumption. This may be useful to a person selecting an AI engine to use for various use cases. For example, if having the highest quality of the response is important regardless of time or power consumption, (e.g., if AI is being used in scientific research, legal research, or legal case preparation (e.g., document review)) the AI engine with the highest response score may be selected. If the fastest run time is important (e.g., when there is little time to generate a response, for example, if a question must be answered in real-time after it is presented), the AI engine with the fastest run time may be selected. If power consumption is important, for example, if the AI engine is running on an edge device that is not connected to an energy grid and has little battery power, the AI engine with the lowest power consumption may be used.

The GUI includes a recommendation section. The recommendation section includes a summary of recommendations of which AI engines to deploy based on priorities (e.g., response score, run time, and/or power usage) the user may have. As shown, the recommendation section includes natural language text.

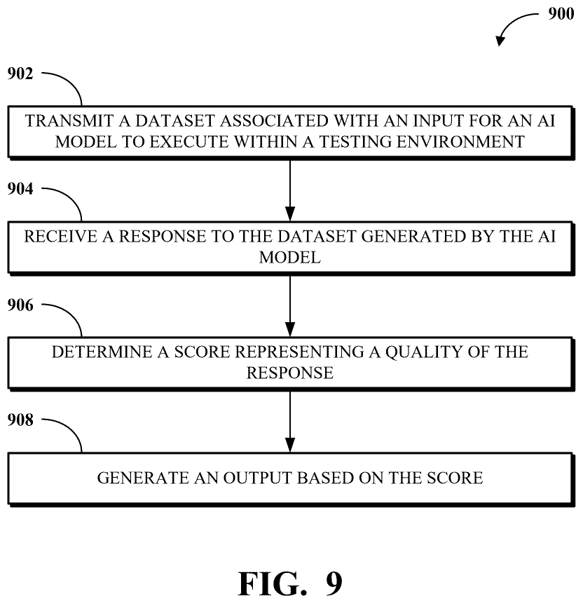

To further describe some implementations in greater detail, reference is next made to examples of techniques for the secure evaluation of an artificial intelligence engine. FIG. 9 is a flowchart of an example of a technique 900 for the secure evaluation of an artificial intelligence engine. The technique 900 can be executed using computing devices, such as the systems, hardware, and software described with respect to FIGS. 1-8. The technique 900 can be performed, for example, by executing a machine-readable program or other computer-executable instructions, such as routines, instructions, programs, or other code. The steps, or operations, of the technique 900 or another technique, method, process, or algorithm described in connection with the implementations disclosed herein can be implemented directly in hardware, firmware, software executed by hardware, circuitry, or a combination thereof.

For simplicity of explanation, the technique 900 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The technique 900 may be performed by a computer system which may include one or more computing devices (e.g., the computing device 100). The computer system may correspond to the system 400 of FIG. 4.

At 902, the computer system transmits, to a testing environment (e.g., the treatment environment 404) and by a scoring engine (e.g., the scoring engine 410) configured to evaluate output of AI models, a dataset (e.g., the dataset 502) associated with an input for an AI model (e.g., one of the treatment engines 416A-C) to execute within the testing environment. The scoring engine 410 may include at least one transformer or may be coupled with an LLM engine (e.g., the LLM engine 412 and/or a GPT) including at least one transformer.

At 904, the computer system receives, by the scoring engine and from the testing environment, a response to the dataset generated by the AI model. In some implementations, the testing environment includes a sandbox that restricts access of the AI model to at least one of network-based data, stored data of a communication service, or stored data of an entity (e.g., a business, a non-profit, or a government organization).

At 906, the computer system determines, using at least one transformer and based on the dataset and the response, a score representing a quality of the response. The score may be a pass or fail (e.g., pass if the response is acceptable, or fail if the response is not acceptable). Alternatively, the score may be a numeric score representing the quality or another representation of the quality.

At 908, the computer system generates an output based on the score. In some cases, the output is a visual output. The output may be displayed by the computer system or may be transmitted to a client device for display at the client device. The output may include displaying the score or a representation of the score on a display device. Alternatively, the output may be based on a combination of scores (e.g., an average score) for the AI engine.

The output may be a dashboard that includes outputs for multiple different AI engines, and may include comparisons of the AI engines (e.g., as illustrated in FIG. 8). In some cases, the dashboard represents scores and execution metrics for multiple artificial intelligence models, including the artificial intelligence model. The execution metrics may include at least one of an execution time, a memory usage value, a processor usage value, or a network usage value. The dashboard may be displayed by the computer system or may be transmitted to a client device outside the computer system for display thereat.

In some cases, the output includes a signal to implement the AI model in an inference environment based on the score being with a range (e.g., the score being a passing score or the score exceeding a threshold value). Alternatively, the signal to implement the AI model in the inference environment may be generated based on the score of the AI model exceeding the score of another AI model developed to solve the same problem as the AI model.

Some implementations are described below as numbered examples (Example 1, 2, 3, etc.). These examples are provided as examples only and do not limit the other implementations disclosed herein.

Example 1 is a method, comprising: transmitting, to a testing environment by a scoring engine, a dataset associated with an input for an artificial intelligence model to execute within the testing environment, the scoring engine comprising at least one transformer; receiving, by the scoring engine and from the testing environment, a response to the dataset generated by the artificial intelligence model; determining, by the scoring engine and based on the response, a score representing a quality of the response; and generating, by the scoring engine, an output based on the score.

In Example 2, the subject matter of Example 1 includes, wherein generating the output comprises: generating a dashboard representing scores and execution metrics for multiple artificial intelligence models, including the artificial intelligence model, wherein the execution metrics comprise at least one of an execution time, a memory usage value, a processor usage value, or a network usage value; and transmitting the dashboard for display at a client device.

In Example 3, the subject matter of Examples 1-2 includes, wherein the output comprises a signal to implement the artificial intelligence model in an inference environment based on the score being within a range.

In Example 4, the subject matter of Examples 1-3 includes, wherein the at least one transformer comprises at least one generative pretrained transformer.

In Example 5, the subject matter of Examples 1-4 includes, wherein the at least one transformer comprises at least one large language model.

In Example 6, the subject matter of Examples 1-5 includes, obtaining the artificial intelligence model from a production environment; and storing the artificial intelligence model in the testing environment.

In Example 7, the subject matter of Examples 1-6 includes, wherein the testing environment comprises a sandbox restricting access of the artificial intelligence model to at least one of network-based data or stored data of a communication service.

In Example 8, the subject matter of Examples 1-7 includes, wherein the artificial intelligence model is specialized for a specific natural language processing task, wherein the at least one transformer comprises a general purpose natural language processing engine.

In Example 9, the subject matter of Examples 1-8 includes, training, using online learning, the artificial intelligence model based on the score.

In Example 10, the subject matter of Examples 1-9 includes, generating, by the scoring engine, a natural language explanation of reasoning for the score and suggested improvements for the response; and training, using online learning, the artificial intelligence model based on at least one of the natural language explanation or the suggested improvements.

In Example 11, the subject matter of Examples 1-10 includes, wherein the scoring engine is configured to evaluate output of artificial intelligence models.

Example 12 is a non-transitory computer readable medium storing instructions operable to cause one or more processors to perform operations comprising: transmitting, to a testing environment by a scoring engine, a dataset associated with an input for an artificial intelligence model to execute within the testing environment, the scoring engine comprising at least one transformer; receiving, by the scoring engine and from the testing environment, a response to the dataset generated by the artificial intelligence model; determining, by the scoring engine and based on the response, a score representing a quality of the response; and generating, by the scoring engine, an output based on the score.

In Example 13, the subject matter of Example 12 includes, wherein generating the output comprises: generating a dashboard representing scores and execution metrics for a plurality of artificial intelligence models, including the artificial intelligence model, wherein the execution metrics comprise at least one of an execution time, a memory usage value, a processor usage value, or a network usage value; and transmitting the dashboard for display at a client device.

In Example 14, the subject matter of Examples 12-13 includes, wherein the output comprises a message to implement the artificial intelligence model in an inference environment based on the score being within a range.

In Example 15, the subject matter of Examples 12-14 includes, wherein the at least one transformer comprises at least one of a generative pretrained transformer or a large language model.

In Example 16, the subject matter of Examples 12-15 includes, the operations further comprising: obtaining the artificial intelligence model from a production engine; and storing the artificial intelligence model in the testing environment.

In Example 17, the subject matter of Examples 12-16 includes, wherein the testing environment comprises a sandbox that restricts access of the artificial intelligence model to at least one of network-based data or stored data of an entity.

Example 18 is a system, comprising: a memory subsystem storing instructions; and processing circuitry configured to execute the instructions to: transmit, to a testing environment by a scoring engine, a dataset associated with an input for an artificial intelligence model to execute within the testing environment, the scoring engine comprising at least one transformer; receive, by the scoring engine and from the testing environment, a response to the dataset generated by the artificial intelligence model; determine, by the scoring engine and based on the response, a score representing a quality of the response; and generate, by the scoring engine, an output based on the score.

In Example 19, the subject matter of Example 18 includes, the processing circuitry further configured to execute the instructions to: train the artificial intelligence model based on the score.

In Example 20, the subject matter of Examples 18-19 includes, the processing circuitry further configured to execute the instructions to: generate, by the scoring engine, an explanation of reasoning for the score and suggested improvements for the response; and train, using online learning, the artificial intelligence model based on at least one of the explanation or the suggested improvements.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

As used herein, unless explicitly stated otherwise, any term specified in the singular may include its plural version. For example, “a computer that stores data and runs software,” may include a single computer that stores data and runs software or two computers—a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry. The memory subsystem may include a single memory unit or multiple joint or disjoint memory units, which each of the multiple joint or disjoint memory units storing all or a portion of the data described as being stored in the memory subsystem.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
transmitting, to a testing environment by a scoring engine, a dataset associated with an input for an artificial intelligence model to execute within the testing environment, the scoring engine comprising at least one transformer;
receiving, by the scoring engine and from the testing environment, a response to the dataset generated by the artificial intelligence model;
determining, by the scoring engine and based on the response, a score representing a quality of the response; and
generating, by the scoring engine, an output based on the score.

2. The method of claim 1, wherein generating the output comprises:
generating a dashboard representing scores and execution metrics for multiple artificial intelligence models, including the artificial intelligence model, wherein the execution metrics comprise at least one of an execution time, a memory usage value, a processor usage value, or a network usage value; and
transmitting the dashboard for display at a client device.

3. The method of claim 1, wherein the output comprises a signal to implement the artificial intelligence model in an inference environment based on the score being within a range.

4. The method of claim 1, wherein the at least one transformer comprises at least one generative pretrained transformer.

5. The method of claim 1, wherein the at least one transformer comprises at least one large language model.

6. The method of claim 1, further comprising:
obtaining the artificial intelligence model from a production environment; and
storing the artificial intelligence model in the testing environment.

7. The method of claim 1, wherein the testing environment comprises a sandbox restricting access of the artificial intelligence model to at least one of network-based data or stored data of a communication service.

8. The method of claim 1, wherein the artificial intelligence model is specialized for a specific natural language processing task, wherein the at least one transformer comprises a general purpose natural language processing engine.

9. The method of claim 1, further comprising:
training, using online learning, the artificial intelligence model based on the score.

10. The method of claim 1, further comprising:
generating, by the scoring engine, a natural language explanation of reasoning for the score and suggested improvements for the response; and
training, using online learning, the artificial intelligence model based on at least one of the natural language explanation or the suggested improvements.

11. The method of claim 1, wherein the scoring engine is configured to evaluate output of artificial intelligence models.

12. A non-transitory computer readable medium storing instructions operable to cause one or more processors to perform operations comprising:
transmitting, to a testing environment by a scoring engine, a dataset associated with an input for an artificial intelligence model to execute within the testing environment, the scoring engine comprising at least one transformer;
receiving, by the scoring engine and from the testing environment, a response to the dataset generated by the artificial intelligence model;
determining, by the scoring engine and based on the response, a score representing a quality of the response; and
generating, by the scoring engine, an output based on the score.

13. The non-transitory computer readable medium of claim 12, wherein generating the output comprises:
generating a dashboard representing scores and execution metrics for a plurality of artificial intelligence models, including the artificial intelligence model, wherein the execution metrics comprise at least one of an execution time, a memory usage value, a processor usage value, or a network usage value; and
transmitting the dashboard for display at a client device.

14. The non-transitory computer readable medium of claim 12, wherein the output comprises a message to implement the artificial intelligence model in an inference environment based on the score being within a range.

15. The non-transitory computer readable medium of claim 12, wherein the at least one transformer comprises at least one of a generative pretrained transformer or a large language model.

16. The non-transitory computer readable medium of claim 12, the operations further comprising:
obtaining the artificial intelligence model from a production engine; and
storing the artificial intelligence model in the testing environment.

17. The non-transitory computer readable medium of claim 12, wherein the testing environment comprises a sandbox that restricts access of the artificial intelligence model to at least one of network-based data or stored data of an entity.

18. A system, comprising:
a memory subsystem storing instructions; and
processing circuitry configured to execute the instructions to:
transmit, to a testing environment by a scoring engine, a dataset associated with an input for an artificial intelligence model to execute within the testing environment, the scoring engine comprising at least one transformer;
receive, by the scoring engine and from the testing environment, a response to the dataset generated by the artificial intelligence model;
determine, by the scoring engine and based on the response, a score representing a quality of the response; and
generate, by the scoring engine, an output based on the score.

19. The system of claim 18, the processing circuitry further configured to execute the instructions to:
train the artificial intelligence model based on the score.

20. The system of claim 18, the processing circuitry further configured to execute the instructions to:
generate, by the scoring engine, an explanation of reasoning for the score and suggested improvements for the response; and
train, using online learning, the artificial intelligence model based on at least one of the explanation or the suggested improvements.
